(19) United States
(12) Patent Application Publication
(10) Pub. No.: US 2005/0155290 A1
(43) Pub. Date: Jul. 21, 2005

(54) Bracket for window regulator window regulator and vehicle body

(76) Inventors: Patrice Cardine, Orleans (FR); Denis Chevy, Neuvy En Sullias (FR)

Correspondence Address: CARLSON, GASKEY & OLDS, P.C., 400 WEST MAPLE ROAD, SUITE 350, BIRMINGHAM, MI, 48009, US

(21) Appl. No.: 10/511,119

(22) PCT Filed: Feb. 13, 2004
(86) PCT No.: PCT/FR04/00334

(30) Foreign Application Priority Data
Feb. 14, 2003 (FR) 0301816

(51) Int. Cl. E05F 11/48

(52) U.S. Cl. 49/352

(57) ABSTRACT

A vehicle window regulator includes a fixing lug including a first part for fixing to a window guide rail having a window-guiding direction and a second part for fixing to a vehicle body. The second part defines a plane, and a normal line perpendicular to the plane that is inclined relative to the window-guiding direction. The normal line is preferably inclined at an angle of approximately 45° relative to the window-guiding direction. The lug can be fixed in the vehicle body without the lug turning on itself during fixing by screwing for example.

### BACKGROUND OF THE INVENTION

This invention relates to a lug for fixing a window regulator, a window regulator and a vehicle body.

A problem arises in relation to the fixing of window regulators in vehicle doors, in particular in vehicles that do not have a frame around the window glass, either in frameless doors or for rear quarter windows (rear side panel of the body of the vehicle). As the window glass is not guided by a frame, the window regulator must be fixed in a precise manner so that the window glass enters the roof in its raised position. It must therefore be possible to adjust the rails by a rotation around an axis parallel to the direction of movement of the vehicle.

A solution has been proposed in the vehicle known as Pluriel produced by the Citroën company. The rail is fixed into the bodywork with a lug. The lug for fixing the rail comprises a fixing part tangent to a circle having as an axis the upper rotation point and with a radius equal to the distance between the lug and the rotation axis. The lug is resting on a bridge fitting in the door, the bridge fitting having a surface cooperating with the fixing part. A screw is inserted into this part, parallel to the rail, and allows for the lug to be fixed to the surface of the bridge fitting. To prevent the lug and, consequently, the rail rotating about themselves during screwing, the lug has two fins on either side of the fixing part. The fins are inclined in relation to the fixing part and cooperate with corresponding surfaces on the bridge fitting.

The drawback is that the lug and the bridge fitting are complex to manufacture. The fins and the corresponding surfaces on the bridge fitting are difficult to produce and require great precision in manufacturing to be sure they cooperate correctly.

### SUMMARY OF THE INVENTION

There is therefore a need for a lug for fixing a window regulator in a vehicle body that is simple to manufacture and prevents the lug from rotating on itself when it is fixed in the body.

For this purpose the invention provides a lug for fixing a window regulator, comprising a first part for fixing to a rail having a window-guiding direction, and a second part for fixing to a vehicle body, the second part being in a plane having a normal that is inclined in relation to the guiding direction.

According to one embodiment, the normal to the second part is inclined at an angle of approximately 45° in relation to the window-guiding direction.

According to another embodiment, the parts are connected to each other by a connection extending in a plane perpendicular to the plane containing the guiding direction.

According to yet another embodiment, the second fixing part comprises a hole for the passage of a member for fixing the lug on the body of the vehicle. The hole is for example oblong.

The invention also provides a window regulator comprising a lug such as described previously, and a guide rail defining a window-guiding direction, carrying the lug at one of its ends.

According to one embodiment, the window regulator also comprises a window slide guided by the rail.

According to another embodiment, the rail is a window runner.

The invention also provides a body with the window regulator as described previously and a bridge fitting for fixing the window regulator in the body.

For example, the bridge fitting has a surface the normal of which is inclined in relation to the guiding direction.

Other characteristics and advantages of the invention will become apparent when reading the following detailed description of the embodiments of the invention, given as an example only and with reference to the drawings.

### BRIEF DESCRIPTION OF THE DRAWINGS

FIG. 1 shows a fixing lug according to the invention;

FIGS. 2 and 3 show different embodiments of the lug in FIG. 1.

### DETAILED DESCRIPTION OF PREFERRED EMBODIMENTS

The invention provides particularly a lug for fixing a window regulator, the window regulator having a window-guiding direction. The lug comprises a fixing part that extends in a plane having a normal N that is inclined in relation to the window-guiding direction. This allows for the lug to be fixed in the body without the lug turning on itself during fixing by screwing for example. Moreover, the construction of the lug is simple because it comprises only one part, the normal of which is inclined in relation to the guiding direction.

Below, the coordinate system given on the Figures comprises an axis Z that extends in the direction of the height of the vehicle, an axis X along the direction of movement of the vehicle, and an axis Y in a direction transverse to the vehicle, orthogonal to the X and Z axes.

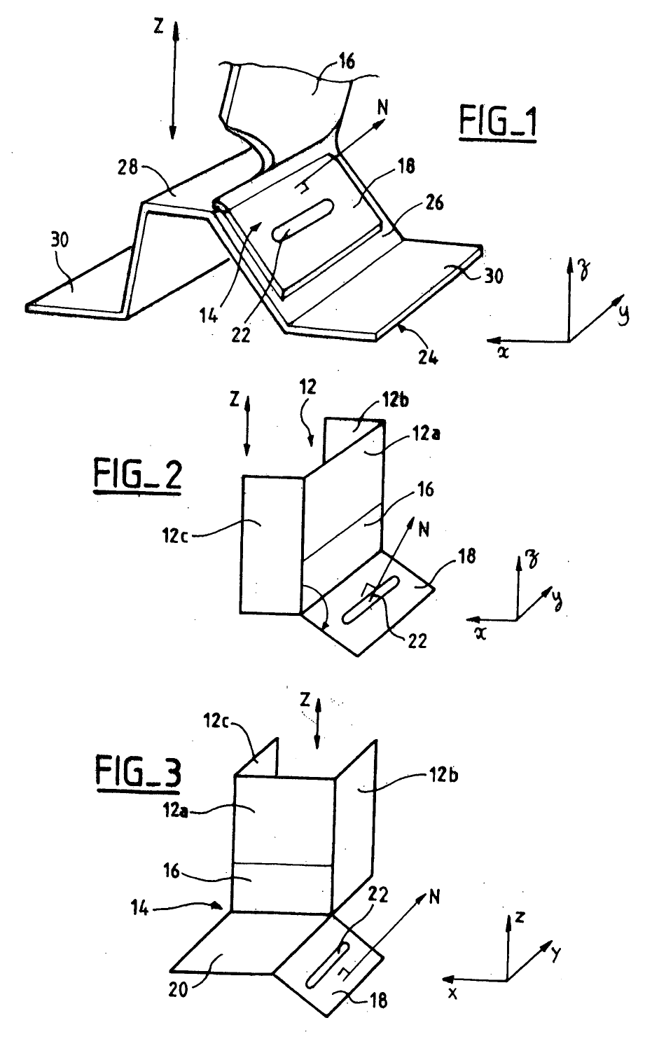

FIG. 1 shows a fixing lug according to an embodiment of the invention. The lug allows for the fixing of the window regulator in a vehicle body without a window frame. The term body here means a vehicle door or rear body panel. The lug is for example fixed onto a bridge fitting 24 in the body. The body comprises a window glass actuated by the window regulator. The window regulator has a guiding direction that extends along the axis Z, in the direction of the height of the vehicle. The window regulator is for example a cable or mechanical arm window regulator. The window regulator comprises a window guide rail. The guide rail defines the guiding direction along the axis Z. Hereafter, and to simplify matters, it will be considered that the guiding direction Z is flat while the window glass and the guide rail can be convex. The guide rail is for example a rail guiding a slide drawn by the cable. The guide rail can also be a window runner into which the window glass is fitted and runs in the body.

The lug 14 for fixing the window glass comprises a first part 16 for fixing to the rail, which has the window-guiding direction, and a second part 18 for fixing to the body of the vehicle, the second part extending in a plane having a normal N that is inclined in relation to the guiding direction. The normal N is inclined in relation to the guiding direction Z.

The first part 16 allows for the fixing of the lug 14 to the rail. The first part 16 comprises a flat portion to allow for the fixing of the rail. The fixing of the lug 14 to the rail by the first part 16 is carried out by screwing or welding for example.

The second part 18 allows for the fixing of the lug 14 to the body. The second part 18 is in a plane that is inclined in relation to the flat portion of the first part 16 so that the normal N to the plane of the part 18 is not parallel to the guiding direction Z.

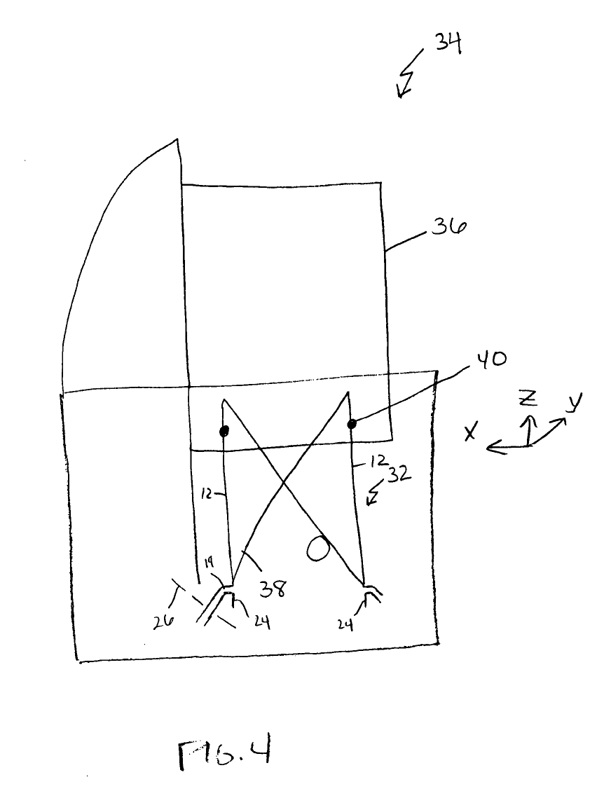

FIGS. 2 and 3 show different embodiments of the lug 14. The first 16 and second 18 parts are obtained for example by pressing a steel plate. The parts can also be joined together by welding. According to FIG. 2, the parts can be joined along an edge extending along the Y axis. According to FIG. 3, the parts can also be joined by a connection 20 extending in a plane that is substantially perpendicular to the plane containing the guiding direction. According to the orientation shown in FIG. 3, the first part 16 is joined to the connection 20 along an edge along the axis X and the second part 18 is joined to the connection 20 along an edge along the Y axis. The connection 20 can be of any shape allowing the two parts 16 and 18 to be joined, in particular a twisted shape to join the planes containing these non-parallel parts.

The guide rail 12 has for example a U-shaped section with a bottom 12a from which lateral arms 12b and 12c extend. The rail can allow for the guiding of a slide along one of its lateral arms 12b, c. The window glass is then parallel to the bottom 12a. Alternatively, the rail can be a runner guiding the window glass directly. The window glass is inserted into the rail and runs along the rail in the body. The window glass is then perpendicular to the bottom 12a. The guiding direction is represented by the arrow Z corresponding to the axis Z of the coordinate system.

According to the embodiment shown in FIG. 2, the first 16 and second 18 parts meet along an edge along the Y axis. The first part 16 is connected to the bottom 12a of the rail 12. The second part 18 of the lug 14 is inclined at an angle α greater than 90°, at approximately 135°. The normal N to the plane containing this second part 18 is then inclined at an angle of approximately 45° in relation to the guiding direction Z of the window.

According to the other embodiment in FIG. 3, the first 16 and second 18 parts are connected by the connection 20. The connection allows for a different orientation of the rail in the body compared to the representation in FIG. 2 in order to adapt the orientation of the rail to the window-guiding mode in the body. The first part 16 is connected to the bottom 12a of the rail 12. The normal N to the plane containing this second part 18 is then inclined at an angle of approximately 45° in relation to the window-guiding direction Z.

It can also be envisaged that the fixing lug be fixed by the first part 16 to one of the arms 12b, c.

Advantageously, the second part 18 for fixing to a vehicle body comprises a hole 22 for the passage of a member for fixing the lug 14 onto the body of the vehicle. The fixing member is for example a screw. The screw is screwed into the second part 18 in the direction of the normal N to the second part. The screw penetrates a circular hole in the bridge fitting and the screw can be self-tapping or a nut can be crimped under the bridge fitting.

The second part 18 allows for the fixing of the rail in the body without causing the deformation of the rail. As the screw is in the direction of the normal N, which is inclined in relation to the window-guiding direction Z, the torque exerted to tighten the screw is thus not exerted around the guiding direction Z. The tightening torque then does not cause the rotation of the lug around the guiding direction. Thus the guide rail of the window regulator does not rotate around this direction either. Because of the fixing lug, the fixing of the window glass thus does not interfere with the guiding of the window glass.

According to one embodiment, the hole 22 for the passage of the fixing member is oblong. This allows for the regulation of the position of the window regulator in the body by adjusting the position of the fixing member along the oblong hole. Preferably, according to FIG. 1, the largest dimension of the oblong hole extends along the Y axis. This allows for the position of the window regulator to be regulated transversally to the direction of movement of the vehicle. This allows for the window regulator to be adjusted in a precise manner in order for the window glass to enter into the roof in its raised position.

It can also be envisaged that the lug be integral with the guide rail. The lug is formed at one end of the rail thus reducing the number of parts. The flat portion of the first part is then merged with the end of the guide rail.

The fixing lug allows for the fixing of the window regulator in the body, either in a rear body panel or a door. The lug 14 can for example allow for the fixing of the upper or lower end of the guide rail. According to FIG. 1, the lug 14 is at the lower end of the rail. The lug is fixed to the bridge fitting 24. The bridge fitting 24 is for example a steel plate that is pressed to give it a shape allowing for cooperation with the lug. The bridge fitting 24 and the lug 14 are for example at the lower end of the rail, the upper end of the rail being able to be fixed in a conventional way to the shell.

The bridge fitting 24 has a surface 26 that cooperates with the second part of the lug. For this purpose the normal to surface 26 is inclined in relation to the window-guiding direction. The surface 26 can include a hole for the passage of the fixing member opposite the hole 22 for fixing the lug 14. The hole in the bridge fitting can be oblong to allow for regulation of the position of the window regulator in the body. Thus the production of the bridge fitting is simplified because only the surface 26 is produced accurately to cooperate with the second part 18 of the lug.

Preferably the connection 20 does not cooperate with the bridge fitting 24 for fixing the lug 14. The lug 14 is only fixed to the bridge fitting 24 by the second part 18. This avoids a hyperstatic connection being set up between the bridge fitting 24 and the lug 14. It also simplifies the production of the bridge fitting and the lug because only one surface of each one cooperates with the other to immobilize the lug in the body.

The bridge fitting can also comprise two tabs 30 for fixing the bridge fitting to the shell of the body.

The orientation of the bridge fitting depends on that of the rail and the lug 14. Preferably the bridge fitting 24 is orientated as shown in FIG. 1, with the normal to the surface 26 in the plane of the axes X and Z, i.e. in the plane of movement of the vehicle. The largest dimension of the bridge fitting preferably extends in this direction of movement of the vehicle, which avoids having to increase the depth of the shell of the body in the direction transverse to the direction of movement.

This invention is of course not limited to the embodiments described as an example. Thus, the vehicle body is not limited to vehicle bodies that do not have a frame around the window glass. The fixing lug is not limited to the forms described. The fixing described is not limited to the fixing of rails but extends also to the fixing of a plate comprising slide runners. Moreover, the oblong fixing hole 22 is not limited to its combination with the described form of the fixing lug.

1. A lug for fixing a vehicle window regulator, the lug comprising.
a first part for fixing to a guide rail, the guide rail having a window-guiding direction; and
a second part for fixing to a vehicle body, the second part defining a plane, and a normal line substantially perpendicular to the plane defined by the second part is inclined relative to the window-guiding direction.

2. The lug according to claim 1, wherein the normal line is inclined at an angle of approximately 45° relative to the window-guiding direction.

3. The lug according to claim 1, wherein the first part is connected to the second part by a connection that extends in a plane substantially perpendicular to plane containing the window-guiding direction.

4. The lug according to claim 3, wherein the second part includes a hole for the passage of a member for fixing the lug onto the vehicle body.

5. The lug according to claim 4, wherein the hole is substantially oblong.

6. A window regulator comprising.
a lug including:
a first part for fixing to a guide rail, the guide rail having a window-guiding direction; and
a second part for fixing to a vehicle body, the second part defining a plane, wherein a normal line substantially perpendicular to the plane defined by the second part is inclined relative to the window-guiding direction; and
the guide rail having an end, and the guide rail carries the lug at the end.

7. The window regulator according to claim 6, further including a window slide guided by the guide rail.

8. The window regulator according to claim 6, wherein the guide rail is a window runner.

9. A vehicle body comprising:
a window regulator including a lug, the lug including:
a first part for fixing to a guide rail having a window-guiding direction; and
a second part for fixing to a vehicle body and defining a plane, wherein a normal line substantially perpendicular to the plane defined by the second part is inclined relative to the window-guiding direction;
the guide rail including an end, wherein the guide rail carries the lug at the end; and a bridge fitting for fixing the window regulator in the vehicle body.

10. The body according to the claim 9, wherein the bridge fitting inclined relative to the window-guiding direction.
